(19) United States
(12) Patent Application Publication
(10) Pub. No.: US 2011/0186700 A1
(43) Pub. Date: Aug. 4, 2011

(54) TOOL RACK HOLDER

(76) Inventor: Jui-Chien Kao, Tali (TW)

(21) Appl. No.: 12/699,393

(22) Filed: Feb. 3, 2010

(51) Int. Cl. F16M 13/00

(52) U.S. Cl. 248/201

(57) ABSTRACT

A tool rack holder has a pasteboard and two brackets. The pasteboard has two aligned mounting holes. The brackets are mounted on the pasteboard, and correspond to the mounting holes, and each has a back board, a cover and a fastener. The back board is attached to the pasteboard and has a connecting tube inserted through the corresponding mounting hole. The cover is mounted on the pasteboard opposite to the back board, and has an inner surface, two side boards and a mounting tube. The side boards protrude parallel from the inner surface, and has a pair of rail recesses aligned and formed through the side boards. The mounting tube protrudes from the inner surface, and mounted on the connecting tube. The fastener is inserted through the mounting tube and the connecting tube to connect the cover and the back board.

### BACKGROUND OF THE INVENTION

1. Field of the Invention

The present invention relates to a tool rack holder, and more particularly to a tool rack holder with a pasteboard and two brackets mounted on the pasteboard to hold and package at least one tool rack stably and economically.

2. Description of the Prior Art

A conventional tool rack packaging is used to hold and provide a protecting effect to a tool rack and allow the tool rack to be hung on a shelf. A tool rack is used to hang and display hand tools and has a base, a rail and multiple hangers. The base is elongated and has two rectangular fastening holes formed respectively through two sides of the base. The rail is elongated and protrudes from the base. The hangers are slidably attached to the rail. The conventional tool rack packaging has a pasteboard and a plastic casing. The pasteboard has a hanging hole. The tool rack is attached to the pasteboard. The plastic casing is mounted on the pasteboard and encloses the tool rack.

However, the conventional tool rack packaging has the plastic casing mounted around and enclosing the tool rack so a space is defined between the casing and the tool rack. The space between the plastic casing and the tool rack increases the volume of the whole tool rack packaging and this increases space and costs for displaying, storing and transporting the tool rack packaging. Furthermore, the conventional tool rack packaging is only used once and has to be discarded after sale and this wastes material and increases manufacturing cost without imparting practical consumer benefits.

To overcome the shortcomings, the present invention provides a tool rack holder to mitigate or obviate the aforementioned problems.

### SUMMARY OF THE INVENTION

The main objective of the invention is to provide a tool rack holder, and more particularly a tool rack holder with a pasteboard and two brackets mounted on the pasteboard to hold and package at least one tool rack stably and economically.

The tool rack holder has a pasteboard and two brackets. The pasteboard has two aligned mounting holes. The brackets are mounted on the pasteboard, and correspond to the mounting holes, and each has a back board, a cover and a fastener. The back board is attached to the pasteboard and has a connecting tube inserted through the corresponding mounting hole. The cover is mounted on the pasteboard opposite to the back board, and has an inner surface, two side boards and a mounting tube. The side boards protrude parallel from the inner surface, and each has a pair of rail recesses aligned and formed through the side boards. The mounting tube protrudes from the inner surface, and mounted on the connecting tube. The fastener is inserted through the mounting tube and the connecting tube to connect the cover and the back board.

Other objectives, advantages and novel features of the invention will become more apparent from the following detailed description when taken in conjunction with the accompanying drawings.

### BRIEF DESCRIPTION OF THE DRAWINGS

FIG. 1 is a perspective front view of a first embodiment of a tool rack holder in accordance with the present invention;

FIG. 2 is a perspective rear view of the tool rack holder of the tool rack holder in FIG. 1;

FIG. 3 is a partially exploded perspective view of the tool rack holder in FIG. 1;

FIG. 4 is an enlarged top view in partial section of the tool rack holder in FIG. 1;

FIG. 5 is a partially exploded perspective view of a second embodiment of the tool rack holder in accordance with the present invention;

FIG. 6 is an enlarged top view in partial section of the tool rack holder in FIG. 5;

FIG. 7 is a partially exploded perspective view of a third embodiment of the tool rack holder in accordance with the present invention;

FIG. 8 is an enlarged top view in partial section of the tool rack holder in FIG. 7;

FIG. 9 is a partially exploded perspective view of a fourth embodiment of the tool rack holder in accordance with the present invention; and

FIG. 10 is an enlarged top view in partial section of the tool rack holder in FIG. 9.

### DETAILED DESCRIPTION OF THE PREFERRED EMBODIMENTS

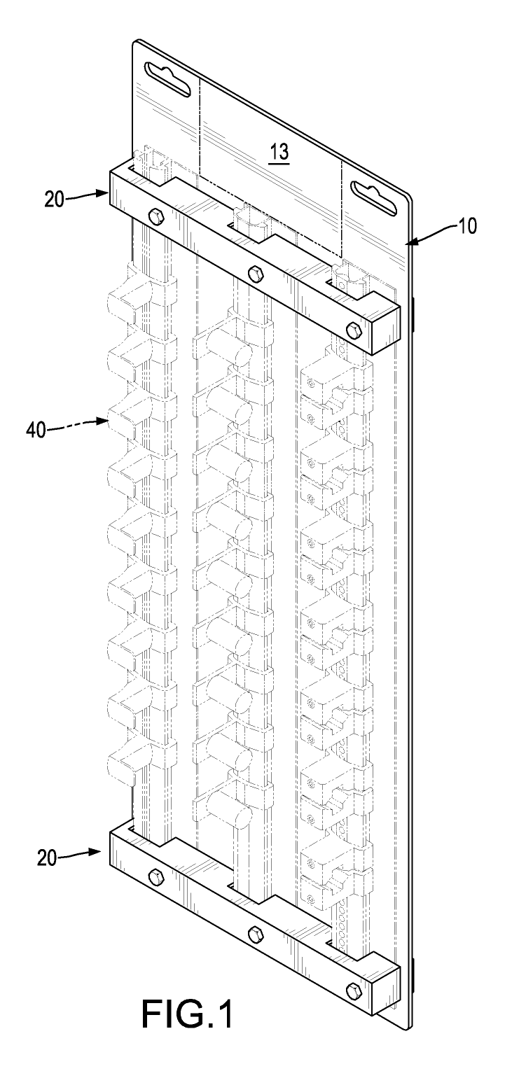

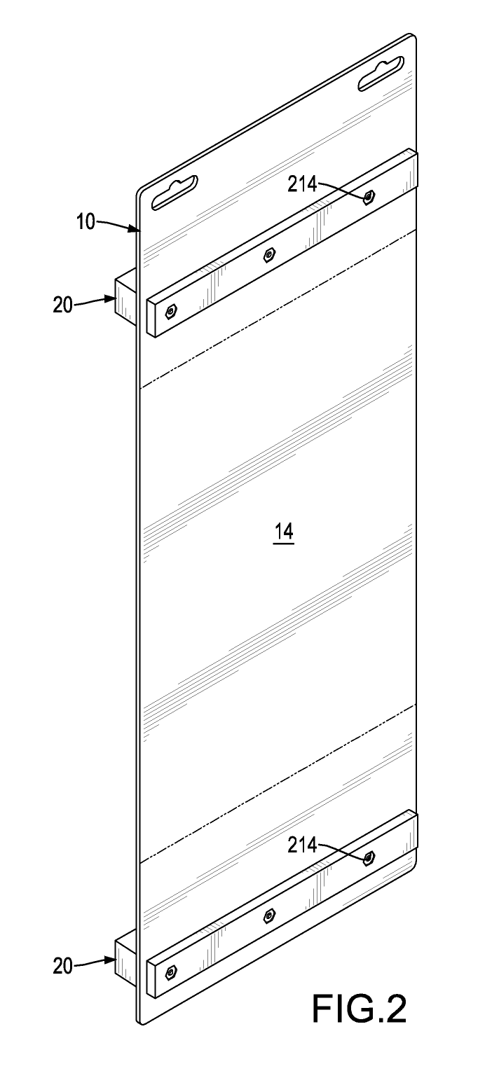

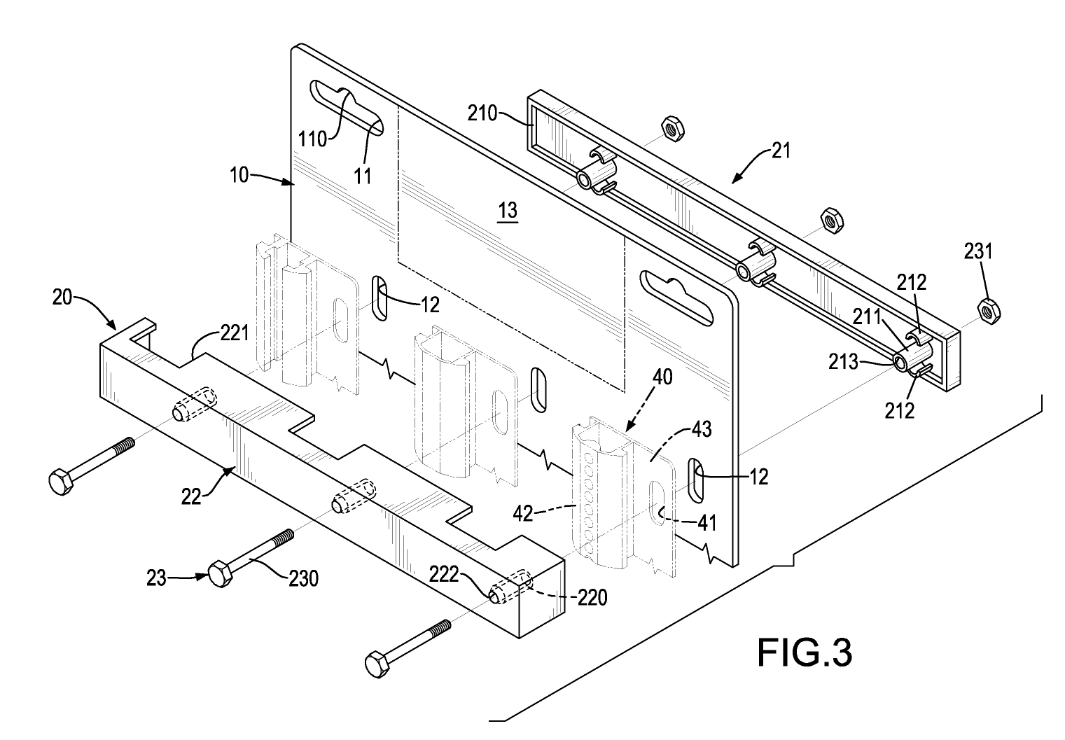

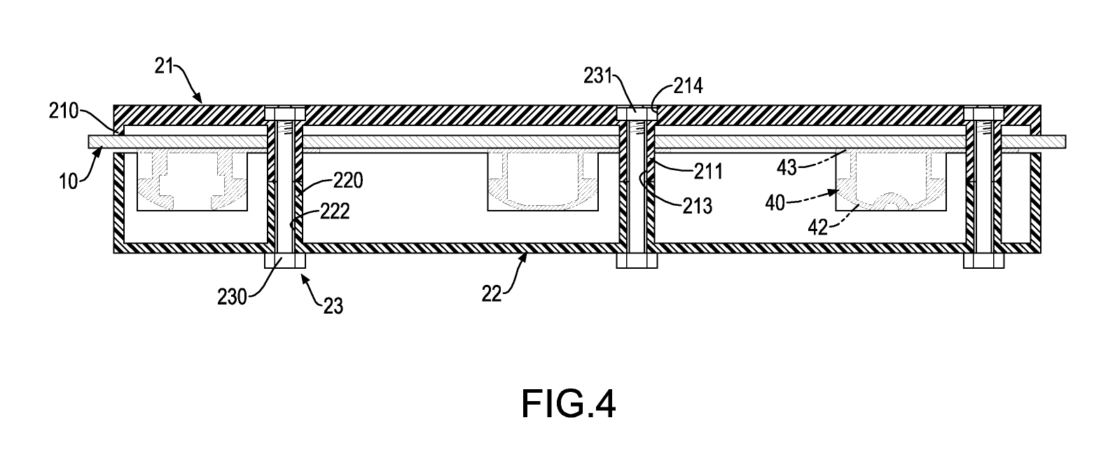

With reference to FIGS. 1 to 4, a first embodiment of a tool rack holder in accordance with the present invention is used to pack three tool racks (40) and has a pasteboard (10) and two brackets (20).

The tool racks (40) are attached to the pasteboard (10) using the brackets (20), and each tool rack (40) has a base (43), a rail (42) and two fastening holes (41). The base (43) is elongated and has two base ends. The rail (42) is elongated and protrudes from the base (43). The fastening holes (41) are formed through the base (43) at respective base ends, and each fastening hole (41) is an elongated elliptic hole and has two curved edges.

The pasteboard (10) is elongated and rectangular and has a front surface, a back surface, two hanging holes (11), three pairs of mounting holes (12), a front mark area (13) and a back mark area (14). The front surface of the pasteboard (10) is defined in the pasteboard (10) and is divided into a top segment and a bottom segment. The back surface of the pasteboard (10) is defined in the pasteboard (10) opposite the front surface of the pasteboard (10). The hanging holes (11) are formed through two ends of the top segment of the pasteboard (10) and are aligned with each other, and each hanging hole (11) is an elongated elliptic hole and has a top side and a cutout (110). The cutout (110) is formed in the pasteboard (10) at the top side of the hanging hole (11) to engage a hook mounted on a shelf.

The three pairs of mounting holes (12) are formed through the bottom segment of the pasteboard (10) and correspond to the tool racks (40). Each pair of mounting holes (12) have an upper mounting hole (12) and a lower mounting hole (12) formed through the bottom segment of the pasteboard (10) and corresponding respectively to the fastening holes (41) of the corresponding tool rack (40). The upper mounting holes (12) are adjacent to the top segment and are aligned with each other. The lower mounting holes (12) align respectively with the upper mounting holes (12) each other. Each mounting hole (12) is an elongated elliptic hole and has two arc edges. The front mark area (13) is defined in the front surface of the pasteboard (10) between the hanging holes (11). The back mark area (14) is defined in the back surface of the pasteboard (10).

The brackets (20) are mounted on the pasteboard (10) parallel to each other and respectively correspond to the upper mounting holes (12) and the lower mounting holes (12).

Each bracket (20) has a back board (21), a cover (22) and three fasteners (23). The back board (21) is rectangular and attached to the back surface of the pasteboard (10) and has an inner surface, an outer surface, a flange (210), three connecting tubes (211) and three pairs of limiting tabs (212). The inner surface of the back board (21) faces the pasteboard (10). The outer surface of the back board (21) is opposite to the inner surface of the back board (21). The flange (210) is formed around and protrudes from the inner surface of the back board (21). The connecting tubes (211) protrude from the inner surface of the back board (21), are respectively inserted through and correspond to the mounting holes (12) of the pasteboard (10) and the fastening holes (41) of the tool racks (40). Each connecting tube (211) has a connecting hole (213) and a nut recess (214). The connecting hole (213) is formed through the connecting tube (211) and the back board (21) and has an inner diameter. The nut recess (214) is formed in the outer surface of the back board (21) around the connecting hole (213).

The three pairs of limiting tabs (212) are mounted on and protrude from the inner surface of the back board (21). Each pair of limiting tabs (212) corresponds to and is mounted around one of the connecting tubes (211), is inserted through the corresponding mounting hole (12) of the pasteboard (10) and the fastening holes (41) of the corresponding tool rack (40), and abuts the arc edges of the mounting hole (12) and the curved edges of the fastening hole (41) to hold the tool rack (40) in position.

The cover (22) is elongated, is mounted on the front surface of the pasteboard (10), connects to the back board (21) and has an inner surface, two side boards and three mounting tubes (220). The inner surface of the cover (12) faces the pasteboard (10) and has a top edge and a bottom edge. The side boards of the cover (22) protrude from the top edge and the bottom edge of the inner surface of the cover (22) and are parallel to each other. Each side board has a pressing edge and three rail recesses (221) separately formed through the side board. The rail recesses (211) in the side board are aligned with each other to contain the rails (42) of the tool racks (40). The pressing edges of the side boards of the cover (22) abut against the bases (43) of the tool racks (40). The mounting tubes (220) are formed on and protrude from the inner surface of the cover (22) and correspond to and are mounted on the connecting tubes (211) of the back board (21), and each mounting tube (220) has an inserting hole (222). The inserting hole (222) is formed through the mounting tube (220) and the cover (22) and is aligned with the connecting hole (213) of the corresponding connecting tube (211).

The fasteners (23) are mounted through respective inserting holes (222) of the mounting tubes (220) and connecting holes (213) of the connecting tubes (211) to connect the cover (22) securely with the back board (21), and each fastener (23) has a bolt (230) and a nut (231). The bolt (230) is mounted through the corresponding inserting hole (222) and the corresponding connecting hole (213) from the cover (22) to the back board (21). The nut (231) is hexagonal, is screwed onto the bolt (230) and is mounted in the nut recess (214) of the back board (21).

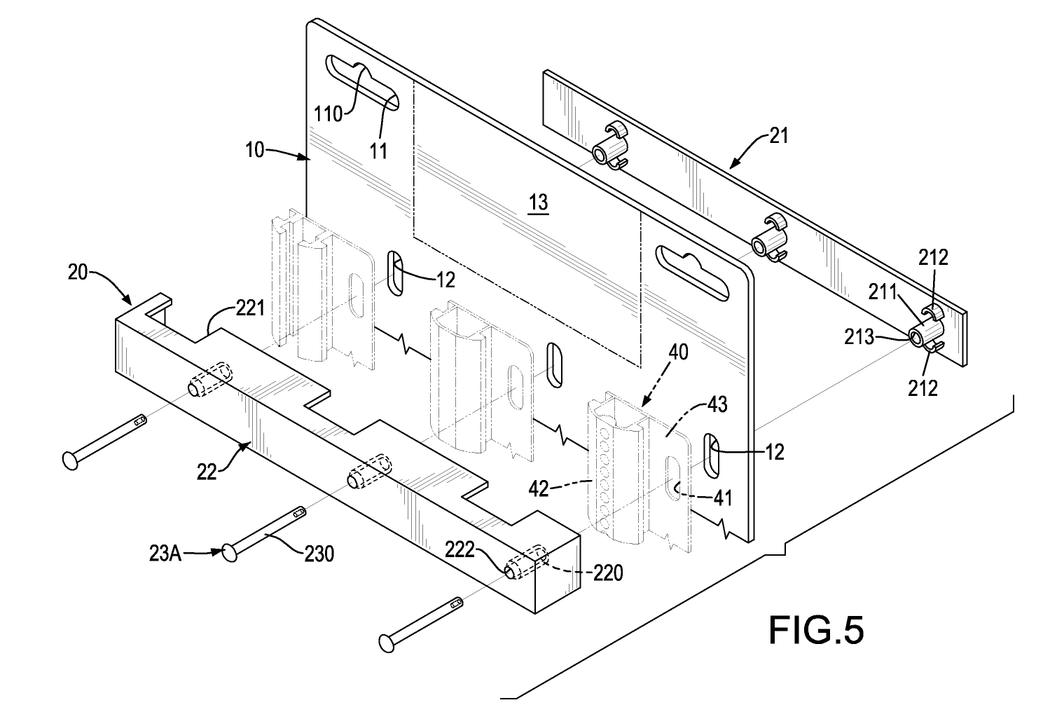

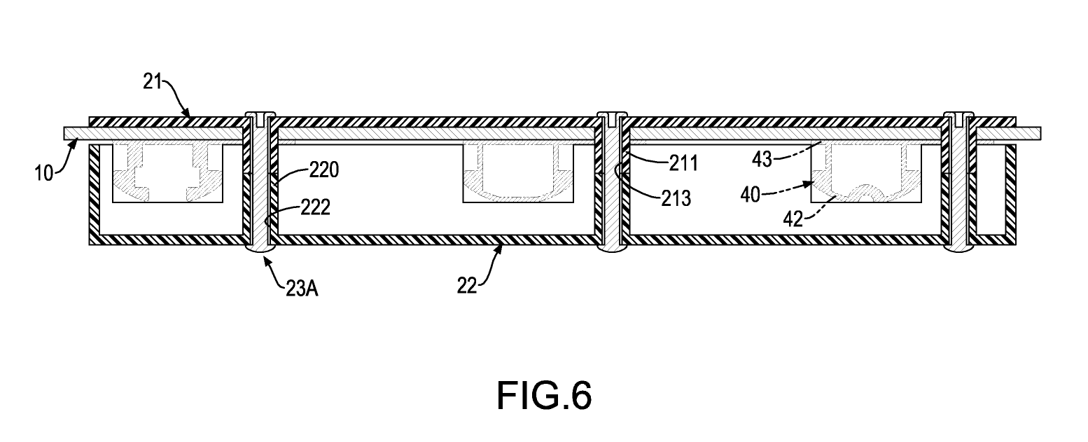

With reference to FIGS. 5 to 6, the second embodiment of the tool rack holder in accordance with the present invention differs from the first embodiment in the shapes of the fasteners (23A). The fasteners (23A) are rivets respectively mounted through the inserting holes (222) of the corresponding mounting tubes (220) and the connecting holes (213) of the corresponding connecting tubes (211), and each rivet has an engaging end enlarged to abut against the back board (21). Furthermore, the back board (21) of the second embodiment is provided without the flange (210), and the inner surface of the back board (21) abuts the back surface of the pasteboard (10).

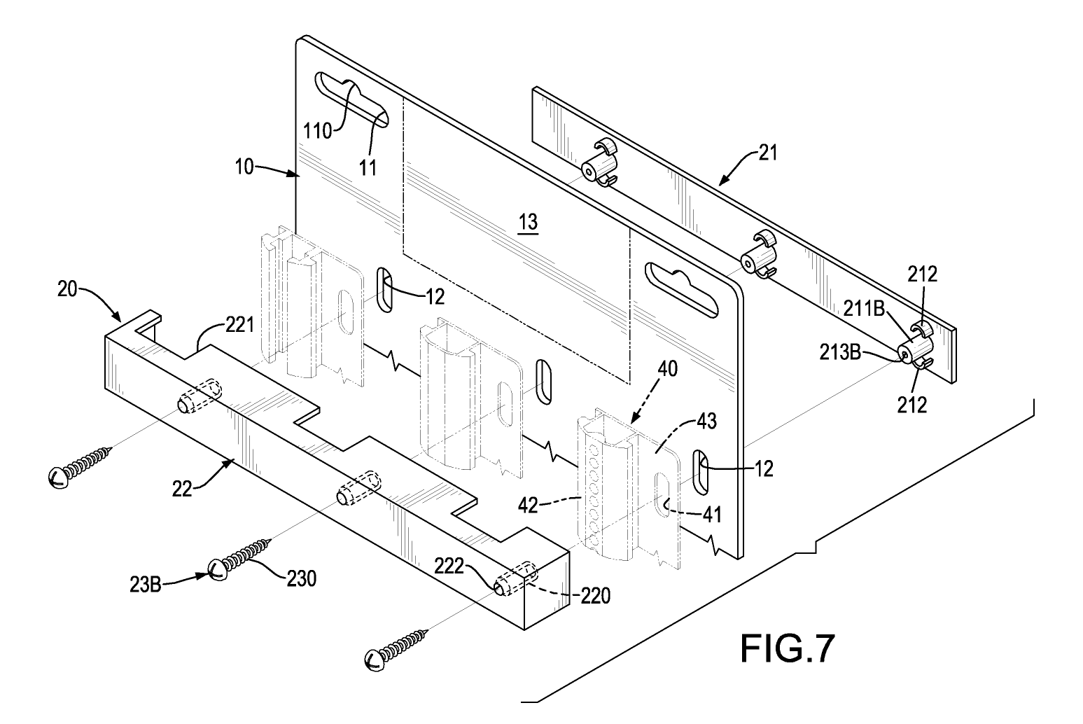

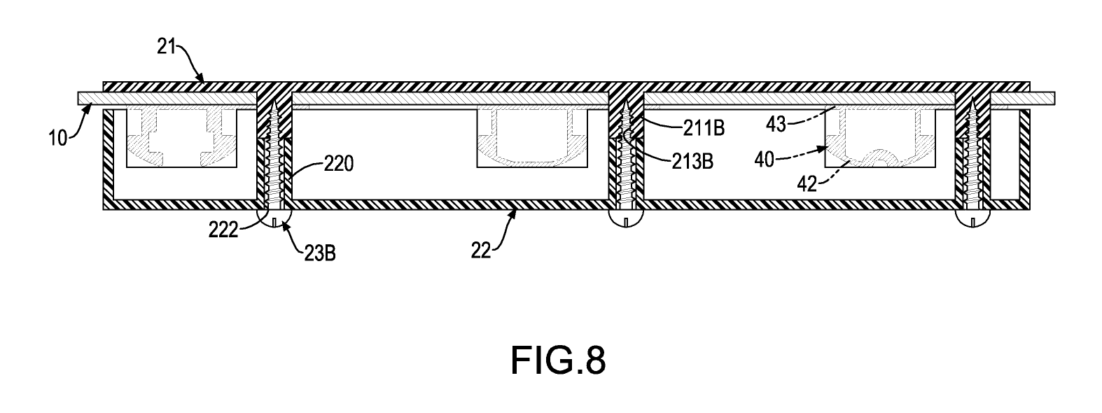

With reference to FIGS. 7 to 8, the third embodiment of the tool rack holder in accordance with the present invention differs from the second embodiment in the shapes of the connecting tubes (211B) and the fasteners (23B). The connecting holes (213B) of the connecting tubes (211B) each has an inner diameter. The fasteners (23B) are screws respectively screwed into the connecting holes (213B) of the connecting tubes (211B), and each fastener (23B) has a threaded diameter larger than the inner diameter of the corresponding connecting hole (213B) to engage the corresponding connecting tube (211B).

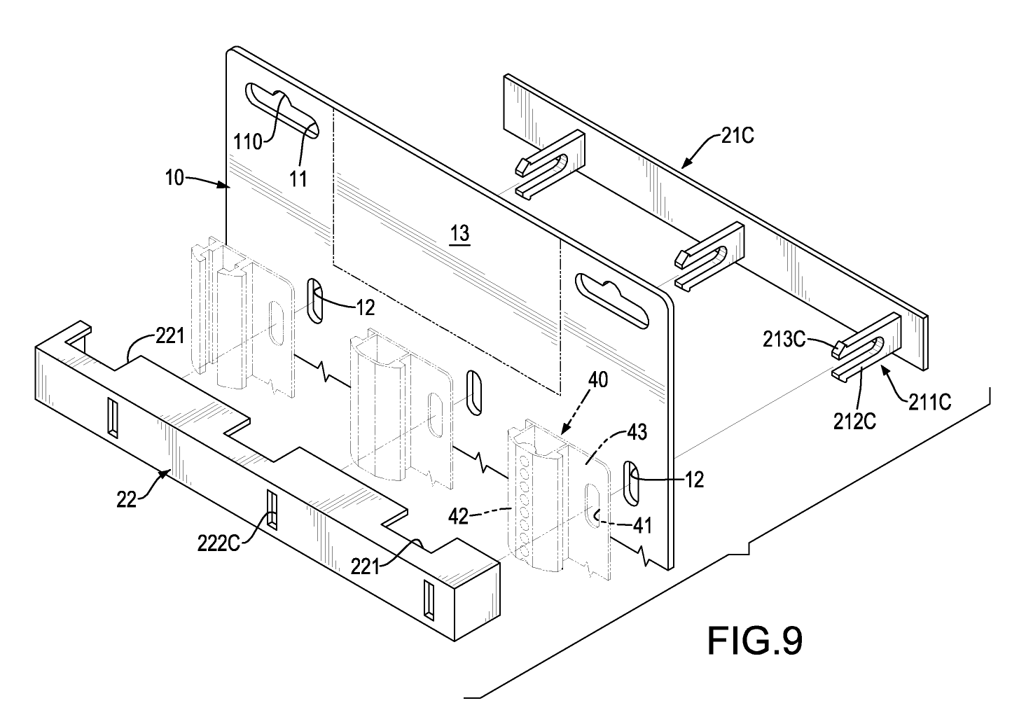

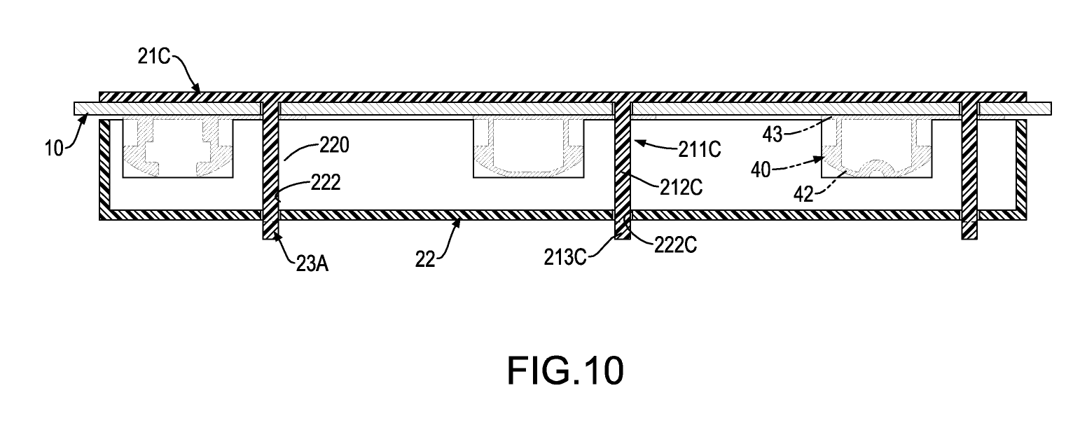

With reference to FIGS. 9 to 10, the fourth embodiment of the tool rack holder in accordance with the present invention differs from the second embodiment in the partial shapes of the cover (22C) and the back board (21C). The cover (22C) has three engaging holes (222C) formed through the inner surface of the cover (21C) respectively corresponding to the mounting holes (12) of the pasteboard (10) and the fastening holes (41) of the tool racks (40).

The back board (21C) is rectangular and attached to the back surface of the pasteboard (10) and has an inner surface and three engaging tabs (211C). The engaging tabs (211C) protrude from the inner surface of the back board (21C), are mounted through and correspond to the mounting holes (12) of the pasteboard (10), the fastening holes (41) of the tool racks (40) and the engaging holes (222C) of the cover (22C).

Each engaging tab (211C) has two engaging arms (212C) and two hooks (213C). The engaging arms (212C) protrude from the engaging tab (211C) toward the cover (22C) and has a resilient gap defined between the engaging arms (212C), and each engaging arm (212C) has a hooking end. The hooks (213C) are formed on respective the hooking ends of the engaging arms (212C), and are mounted through a corresponding engaging hole (222C) and hook on the cover (22C) to connect the back board (21C) securely with the cover (22C).

The tool rack holder in accordance with the present invention holds the tool racks (40) stably with the brackets (20) mounted on the pasteboard (10) directly, and may reduce the space for displaying and transporting when the packed tool racks are pilled up. The back boards (21, 21C) and the covers (22, 22C) of the brackets (20) may be reused to prevent material waste.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tool rack holder comprising
a pasteboard having
a front surface;
a back surface opposite to front surface; and
a pair of mounting holes formed through the pasteboard, aligned to each other, each mounting hole formed elongated and having two arc edges;
two brackets mounted on the pasteboard, parallel to each other and respectively corresponding to the mounting holes, and each bracket having
a back board attached to the back surface of the pasteboard, and having
an inner surface facing the pasteboard;
an outer surface opposite to the inner surface;
a connecting tube protruding from the inner surface of the back board, inserted through one of the mounting holes of the pasteboard, and having a connecting hole formed through the connecting tube; and
a pair of limiting tabs protruding from the inner surface of the back board, and mounted around the connecting tube, and inserted through one of the mounting holes of the pasteboard, and abutting the arc edges of the mounting hole;
a cover mounted on the front surface of the pasteboard, connecting to the back board, and having
an inner surface facing the pasteboard;
two side boards protruding from the inner surface of the cover parallel to each other and each having a pair of rail recesses aligned and respectively formed through the side boards;
a mounting tube protruding from the inner surface of the cover, and mounted on the connecting tube of the back board, and having an inserting hole formed through the mounting tube and aligned with the connecting hole; and
a fastener mounted through the inserting hole of the mounting tube and the connecting hole of the connecting tube to connect the cover and the back board.

2. The tool rack holder as claimed in claim 1, wherein
the fastener of each bracket has
a bolt mounted through the inserting hole and the connecting hole; and
a nut screwed onto the bolt to connect the cover and the back board stably.

3. The tool rack holder as claimed in claim 2, wherein
the back board of each assembly further has a nut recess formed in the outer surface of the back board around the connecting hole; and
the nut is mounted in the nut recess.

4. The tool rack holder as claimed in claim 2, wherein
the back board further has a flange formed around and protruding from the inner surface of the back board.

5. The tool rack holder as claimed in claim 1, wherein
the fastener of each assembly is a rivet and has an engaging end enlarged to abut against the back board.

6. The tool rack holder as claimed in claim 1, wherein
each connecting hole of the connecting tubes has an inner diameter; and
the fasteners are screws respectively screwed into the connecting holes of the connecting tubes, and each fastener having a threaded diameter larger than the inner diameter of a corresponding connecting hole to engage on a corresponding connecting tube.

7. The tool rack holder as claimed in claim 6, wherein
the pasteboard further has a hanging hole formed through the pasteboard.

8. The tool rack holder as claimed in claim 1, wherein
the pasteboard further has a hanging hole formed through the pasteboard.

9. A tool rack holder comprising
a pasteboard having
a front surface;
a back surface opposite to front surface; and
a pair of mounting holes formed through the pasteboard, aligned to each other, each mounting hole formed elongated and having two arc edges;
two brackets mounted on the pasteboard parallel to each other and respectively corresponding to the mounting holes, and each bracket having
a cover mounted on the front surface of the pasteboard, connecting to the back board, and having
an inner surface facing the pasteboard;
two side boards protruding from the inner surface of the cover parallel to each other and each having a pair of rail recesses aligned and respectively formed through the side boards; and
an engaging hole formed through the inner surface of the cover, and corresponding to the mounting hole of the pasteboard;
a back board attached to the back surface of the pasteboard and having
an inner surface facing the pasteboard;
an engaging tab protruding from the inner surface of the back board, mounted through the mounting hole of the pasteboard and the engaging hole of the cover, and each engaging tab having
two engaging arms protruding from the engaging tab toward the cover, and has a resilient gap defined between the engaging arms, and each has a hooking end; and
two hooks formed on respective hooking ends of the engaging arms, and mounted through the engaging hole and hooked on the cover to connect the back board and the cover stably.

10. The tool rack holder as claimed in claim 9, wherein
the pasteboard further has a hanging hole formed through the pasteboard.
